(19) United States
(12) Patent Application Publication
(10) Pub. No.: US 2002/0069766 A1
(43) Pub. Date: Jun. 13, 2002

(54) Cookware and method for cooking with same

(76) Inventors: Gerry Paul, Whitelaw, WI (US); Todd Kroscher, Two Rivers, WI (US); Deb Lonneman, Chicago, IL (US)

Correspondence Address: George E. Quillin, FOLEY & LARDNER, Washington Harbour, 3000 K Street, N.W., Suite 500, Washington, DC, 20007-5109, US

(21) Appl. No.: 09/911,835

(22) Filed: Jul. 25, 2001

Related U.S. Application Data
(60) Provisional application No. 60/220,485, filed on Jul. 25, 2000.

(51) Int. Cl. A01K 43/00

(52) U.S. Cl. 99/366; 99/394

(57) ABSTRACT

Cookware includes a cooking vessel; a transparent lid adapted to cover the vessel; and a knob attached to the lid, which knob is adapted to receive a temperature probe, wherein the temperature probe extends into the cookware vessel. The transparent lid permits one to accurately position the temperature probe inside food in the vessel. The knob may be offset from the center of the lid to facilitate positioning of the probe. Particularly while cooking at low temperatures, the transparent lid and temperature probe permits one to more precisely observe the temperature of the food. This results in improved cooking by avoiding either undercooking or overcooking the food.

### FIELD OF THE INVENTION

The present invention relates to cookware, particularly cookware that includes a transparent lid and accommodates a temperature probe. The present invention further relates to a method of cooking using such cookware.

### SUMMARY OF THE INVENTION

In brief, cookware according to an embodiment of the invention includes: a cooking vessel; a transparent lid adapted to cover the vessel; and a knob attached to the lid, which knob is adapted to receive a temperature probe, wherein the temperature probe extends into the cookware vessel. The transparent lid permits one to accurately position the temperature probe inside food in the vessel. According to one aspect of the invention, the knob is offset from the center of the lid to facilitate positioning of the probe. Particularly while cooking at low temperatures, the transparent lid and temperature probe permits one to more precisely observe the temperature of the food. This results in improved cooking by avoiding either undercooking or overcooking the food.

According to another aspect of the invention, there is a method of cooking with the above described cookware.

### BRIEF DESCRIPTION OF THE FIGURES

In the drawings:

FIG. 1 is perspective view of cookware according to an embodiment of the invention in which a knob mounted on a cookware lid covers a cooking vessel, and a thermometer probe that is insertable through the knob into the cooking vessel, is removed;

FIG. 2 is a top view of the knob showing a slide in a closed position;

FIG. 3 is a top view of the knob showing the slide in an open position;

FIG. 4 is an elevational view of the knob taken from the right side of FIG. 2;

FIG. 5 is an elevational view of the knob taken from the left side of FIG. 2;

FIG. 6 is a side view of the knob; the other side is a mirror image;

FIG. 7 is a side cross-sectional view of knob according to an embodiment of the invention.

FIG. 8 is a perspective view of cookware according to the invention wherein a temperature probe is inserted into a cooking vessel through a glass lid; a rack holds thermometers according to the invention; and a glass lid with the thermometer probe removed is shown over a cooking vessel.

### DESCRIPTION

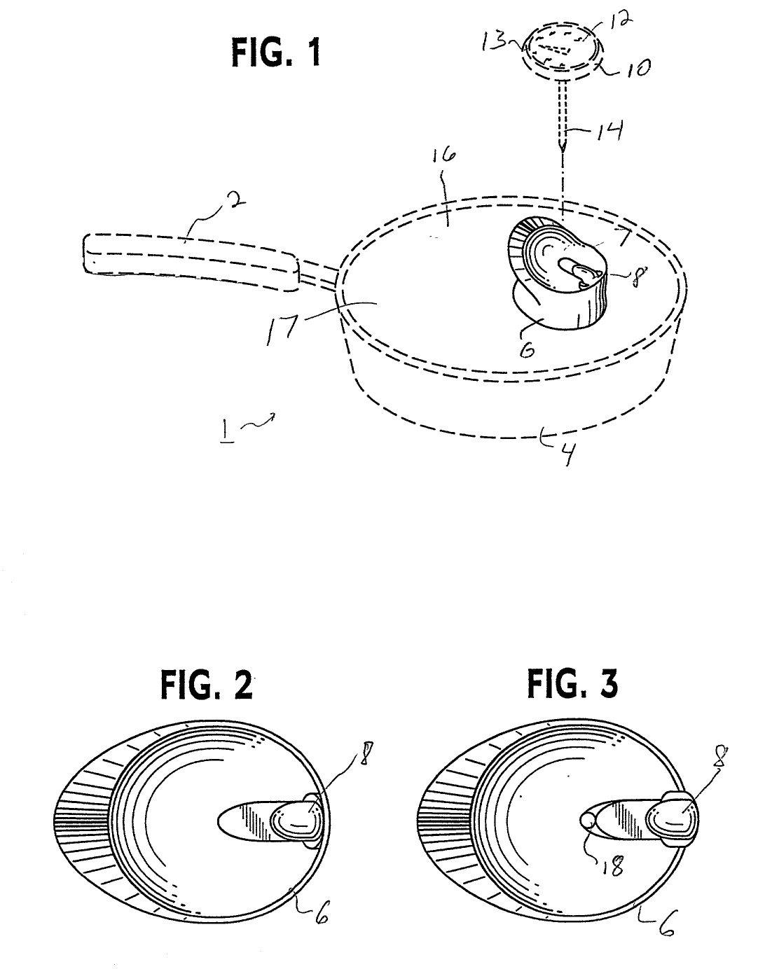

FIG. 1 is perspective view of cookware 1 according to an embodiment of the invention in which a knob 6 is mounted on a lid 16 covers a cooking vessel 4. As shown, a thermometer probe 10 may be removed from or inserted through the knob 6 into the cooking vessel 4. The lid 16 is adapted to fit securely over the vessel 4 to completely cover and close the vessel. According to an aspect of the invention, a portion 17 of the lid 16 is transparent to allow one to observe the contents of the vessel during cooking. The transparent lid 16 further facilitates insertion of the lid into food in the vessel. The lid 16 may be made of transparent glass or other material, with or without a band portion that contacts the rim of the vessel.

FIGS. 2 and 3 provide a top view of the knob 6. As shown, the knob includes a slide 6. In a closed position, shown in FIG. 2, the slide 8 covers an opening 18 that extends through the knob 6 and lid 16 into the vessel. FIG. 3 illustrates an open position of the slide 8 in which the opening 18 is exposed.

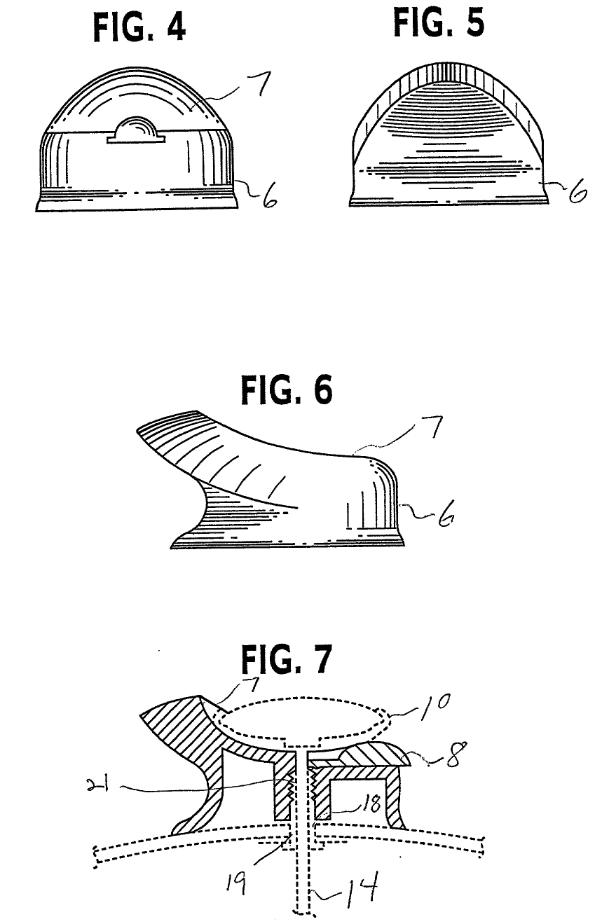

As seen in FIGS. 1, 4, 6 and 7, the knob 6 has a concave top surface adapted to receive a top portion of a thermometer 10. The thermometer 10 has a dial face 14 and a probe 14 with a pointed end to facilitate piercing food inside the vessel.

As shown in FIG. 1, according to another aspect of the invention, the lid is disposed offset from the center of the lid 16. This provides for different positions for thermometer probe 14.

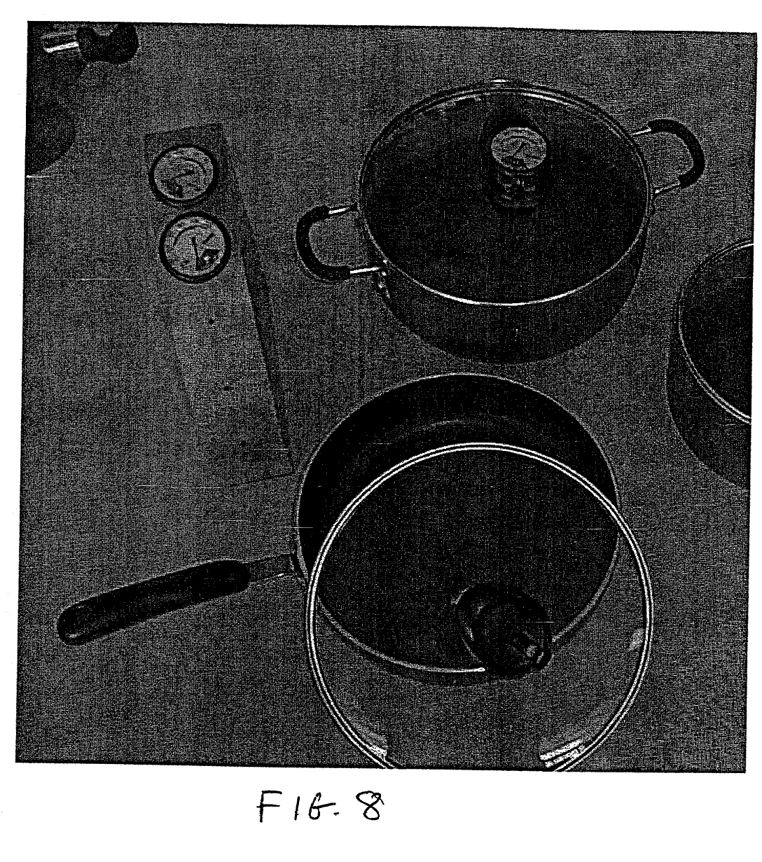

FIG. 7 is a cross-sectional view of the knob 18 and thermometer 10. As shown, the slide 8 is in an open position exposing opening 18, which is comprised of aligned openings 19 and 21, respectively, in the lid 16 and knob 8. The upper portion of the thermometer 10 rests in the knob 8, while the probe 14 extends downward through the opening 18 into the cooking vessel.

FIG. 8 is a perspective view of cookware according to the invention wherein a temperature probe is inserted into a cooking vessel through a glass lid; a rack holds thermometers according to the invention; and a glass lid with the thermometer probe removed is shown over a cooking vessel.

In use, food is placed into the cooking vessel 4 and the lid 16 is securely placed on the vessel. While observing the position of the food through the transparent lid 16, the lid is rotated by holding the lid with knob 6 until the knob is disposed over food inside the vessel. The slide 8 is then retracted and a thermometer 10 is inserted. The probe 14 of the thermometer extends through opening 18 and pierces food in the vessel so that the internal temperature of the food can be monitored. Thus, the cookware according to the invention can be used to cook foods to a predetermined temperature, thus avoiding either undercooking or overcooking.

The cookware according to the invention provides an additional benefit in that the transparent lid avoids the necessity of removing the lid to visual inspect the food being cooked. This tends to better maintain the temperature within the vessel, improving cooking results and shortening cooking time. The use of a thermometer enables cooking at lower temperatures, thus avoiding conditions that tend to obscure the observation through the lid of food being cooked. Accordingly, the combination of the transparent lid and temperature probe significantly improves cooking results.

While an analog thermometer is shown in the above-described embodiments, it will be appreciated that a digital thermometer may also be employed. Further, the thermometer and/or knob may incorporate some type of device to indicate when the temperature measured with the thermometer has reached a predetermined point. For example, a digital thermometer may incorporate a device that emits an audible beep or lights a light emitting diode or provides some other visual signal when the detected temperature reaches a predetermined cooking point. Similarly, the thermometer could incorporate an alarm to indicate that the temperature of food being cooked has exceeded some predetermined level.

Various other embodiments will be apparent to those skilled in the art without departing from the spirit and scope of the invention.

What is claimed is:

1. Cookware comprising:
a cooking vessel;
a transparent lid adapted to cover the vessel;
a knob attached to the lid, which knob is adapted to receive a temperature probe, wherein the temperature probe extends into the cookware vessel.

2. Cookware according to claim 1, wherein the lid is made substantially of glass.

3. Cookware according to claim 1, wherein the knob includes a slide adapted to cover an opening in the lid through which temperature probe extends.

4. Cookware according to claim 1, wherein the knob is disposed at a position offset from the center of the lid.

5. A method of cooking using the lid of claim 1, comprising:
covering the cooking vessel with the lid;
inserting the temperature probe into the contents of the vessel while observing the contents of the vessel through the lid.

6. The method according to claim 5, further comprising observing temperature readings with the temperature probe and regulating the temperature of the contents of the vessel based on the temperature measurements.

7. A method of cooking comprising:
placing food into a cooking vessel;
covering said vessel with a transparent lid, the lid having a knob adapted to receive a thermometer probe through an opening;
inserting the thermometer probe into the food that is in the cooking vessel while observing the food through the lid;
observing the temperature of the food in the cooking vessel as measured by the thermometer probe as heat is applied to the cooking vessel.

8. A method according to claim 7, wherein the knob is offset from a center position of the lid, wherein inserting the thermometer probe includes rotating the lid to position the probe above the food.

9. A method according to claim 7, wherein the knob includes a slide adapted to cover the opening in the lid through which temperature probe extends, wherein inserting the thermometer probe includes moving the slide to expose the opening and inserting the temperature probe through the opening.
